(19) United States
(12) Patent Application Publication
(10) Pub. No.: US 2014/0373752 A2
(43) Pub. Date: Dec. 25, 2014

(54) METHOD AND APPARATUS FOR PRODUCING BLACK DYE PIGMENT

(71) Applicants: Esa HASSINEN, Lappeenranta (FI); Riikka SILMU, Taipalsaari (FI); Mauno MIETTINEN, Lappeenranta (FI); Teuvo LEPPANEN, Taavetti (FI)

(72) Inventors: Esa HASSINEN, Lappeenranta (FI); Riikka SILMU, Taipalsaari (FI); Mauno MIETTINEN, Lappeenranta (FI); Teuvo LEPPANEN, Taavetti (FI)

(73) Assignee: UPM-KYMMENE CORPORATION, Helsinki (FI)

(21) Appl. No.: 14/000,027

(22) PCT Filed: Feb. 13, 2012
(86) PCT No.: PCT/FI2012/050134

§ 371 Date: Oct. 22, 2013

(30) Foreign Application Priority Data
Feb. 16, 2011 (FI) 20115147

(51) Int. Cl. C09C 1/48

(52) U.S. Cl. CPC C09C 1/48
USPC 106/405; 106/400; 422/150; 428/402

(57) ABSTRACT

The present invention relates to a method and an apparatus for producing the raw material (46) used in producing black dye pigment. The invention further relates to a raw material (46) for producing black dye pigment as well as to the use of ash (20,24,26) separated from the raw synthetic gas (12, 14, 18) in the purification of the raw synthetic gas (12, 14, 18) generated in the gasification of a biomass (2, 4, 6) for producing black dye pigment.

### FIELD OF THE INVENTION

The present invention relates to the production of the raw material used in producing black dye pigment and, in particular, to a method according to the preamble of claim 1. The present invention further relates to a raw material for producing black dye pigment and, in particular, to a raw material according to the preamble of claim 15. The present invention also relates to an apparatus according to the preamble of claim 19 for the production of the raw material used in producing black dye pigment as well as to the use of ash separated from raw synthetic gas in the purification of raw synthetic gas produced in the gasification of a biomass according to claim 27.

### BACKGROUND OF THE INVENTION

According to prior art, the raw material used in producing black dye pigment is produced in an oil combustion process, in which oil is imperfectly combusted under low oxygen conditions to generate soot. The soot is further refined into carbon black, which comprises generally at least 95 percent by weight elemental carbon. As is known, the properties of carbon black produced in the imperfect combustion of oil can be changed by alloying into this carbon black coal produced with some other process. One known manner is to alloy into the carbon black coal created as a by-product in the gasification of hydrocarbon.

Generating carbon black from oil creates a great deal of tail gas, which comprises mainly carbon dioxide and nitrogen. Tail gas as such is a significant environmental problem, for which reason it must be treated before it is utilized or passed into the environment. Tail gas comprises, for example, volatile organic compounds, which must be removed from the tail gas by purification devices, which further complicates the production of carbon black by combustion of oil. Further, generating tail gas from oil also causes other harmful emissions and consumes non-renewable natural resources.

### BRIEF DESCRIPTION OF THE INVENTION

The object of the present invention is to provide a method and an apparatus such that above said disadvantages of known art can be resolved. The objects of the present invention are achieved by a method according to the characterizing part of claim 1, which is characterized by that, in the method, biomass is gasified in a gasifier to generate raw synthetic gas, raw synthetic gas is purified in one or more gas purification devices to obtain purified raw synthetic gas and from the ash separated from the raw synthetic gas in the purification of the raw synthetic gas is produced the raw material used in producing black dye pigment. The objects of the present invention are also achieved by a raw material according to the characterizing part of claim 15, which is characterized by that the raw material is substantially composed of ash separated from raw synthetic gas in the purification of the raw synthetic gas created in pursuance of the gasification of a biomass. The objects of the present invention are further achieved by an apparatus according to the characterizing part of claim 19 as well as by the use according to claim 27.

The preferred embodiments of the present invention are the object of the dependent claims.

The basis of the present invention is that ash generated as a by-product in the gasification. of a biomass is used as the raw material for producing black dye pigment. When biomass is gasified in a gasifier, raw synthetic gas is created, from which by further purifying is obtained synthetic gas. Purified synthetic gas can be further refined, for example, for the production of a liquid biofuel. Purification of raw synthetic gas can be performed in one or more gas purification devices. In pursuance of purification, ash created in pursuance of the gasification is separated from the raw synthetic gas. According to the present invention, the raw material used in producing black dye pigment is further produced from the ash separated from the raw synthetic gas.

In one embodiment of the invention, purification of the raw synthetic gas comprises purifying the raw synthetic gas in one or more particulate filters. The ash separated from the raw synthetic gas in the particulate filter is further used for the production of the raw material used in producing black dye pigment. In another embodiment, purification of the raw synthetic gas comprises purifying the raw synthetic gas in one or more cyclones. The ash separated in one or more cyclones from the raw synthetic gas is further used for the production of the raw material used in producing black dye pigment. In yet another embodiment, both ash separated in one or more hot gas filters and ash separated in one or more cyclones is used as the raw material for producing black dye pigment. Further, raw synthetic gas can also be purified in one or more other purification devices and the ash separated in these from the raw synthetic gas can also be used for the production of the raw material used in producing black dye pigment.

According to the invention, the ash separated in the purification of raw synthetic gas generated in gasification can be further purified and its particle size reduced such that a raw material is provided, whose carbon black content and particle size are suitable for the purpose of producing black dye pigment.

The present invention enables, environmentally-friendly using a biomass, the production of the raw material containing carbon black and needed for producing black dye pigment. In this case, it is not necessary to use non-renewable natural resources for the production. Further, the raw material can be produced from the ash, which is created in the gasification of a biomass, wherein the sum efficiency of the gasification process can be improved and the waste flows created can be reduced.

### BRIEF DESCRIPTION OF THE FIGURES

In the following, the invention is described in more detail by means of preferred embodiments and with reference to the accompanying drawings, in which

FIG. 1 is a principle diagram of the biomass gasification process;

FIG. 2 is a flow chart showing one embodiment of the present invention for generating the raw material used in producing black dye pigment;

FIG. 3 is a flow chart showing another embodiment of the present invention for generating the raw material used in producing black dye pigment;

FIG. 4 is a flow chart showing yet another embodiment of the present invention for generating the raw material used in producing black dye pigment; and

FIGS. 5A and 5B show embodiments for reducing the particle size of the ash separated from raw synthetic gas.

### DETAILED DESCRIPTION OF THE INVENTION

In this description and in the claims, by the term “ash” is meant the cyclone ash to be created in the purification of raw synthetic gas created in the gasification of a biomass and/or the filter ash to be created in the purification of pre-purified raw synthetic gas and/or the ash mixture to be created when mixing cyclone ash and filter ash.

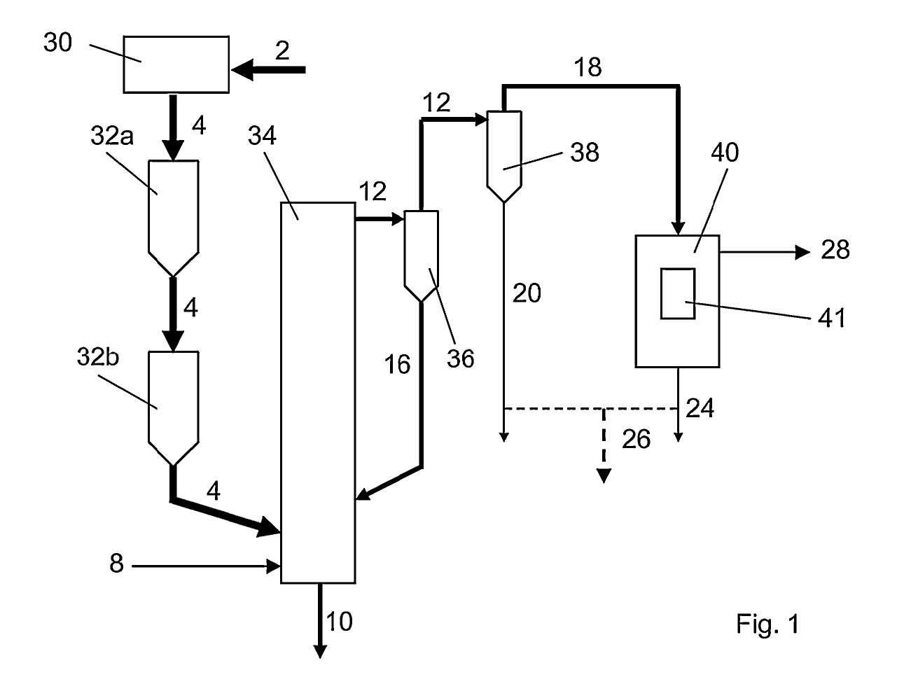

FIG. 1 shows as a flow chart a principle diagram of the biomass gasification process. In the gasification process, biomass 2 is gasified in a gasifier to generate raw synthetic gas 12. The raw synthetic gas 12 is further purified into purified synthetic gas 28, which can be further refined, for example, into a liquid biofuel.

By biomass 2 is herein meant substantially all biomass that can be gasified. The biomass 2 is preferably a solid biomass comprising hydrocarbons or a liquid biomass, which is treated and refined into a solid form. The biomass 2 is typically selected from plants found in nature and their waste, animal and/or fish industry waste or by-products, community waste, agricultural waste or its by-products, forest industry waste or by-products, foodstuffs industry waste and by-products, seaweed or combinations of the above said. The biomass 2 may also comprise vegetable oils, animal fats, fish oils, natural waxes, fatty acids and combinations thereof.

According to FIG. 1, the biomass 2 is initially led into pre-treatment 30, in which the biomass 2 is pre-treated before it is led into the gasifier 34. Pre-treatment 30 of the biomass 2 can comprise crushing of the biomass 2 in a crusher to a suitable size and/or drying of the biomass in a dryer. Drying of the biomass 2 is performed preferably to a moisture content that is less than 20%. Drying is performed preferably using thermal drying.

From pre-treatment 30, the pre-treated biomass 4 is led into the feeder device, through and with which the pre-treated biomass is fed into the gasifier 34. The feeder device can comprise a feeder tank and a lock hopper system for pressurizing the pre-treated biomass 4 and feeding it into the gasifier 34. In the embodiment shown in FIG. 1, the feeder device comprises a lock hopper system, which has two feeder devices 32a and 32b. Preferably, the pre-treated biomass 4 is pressurized in the feeder device substantially to the pressure prevailing inside the gasifier 34.

In the gasifier 34, the biomass 2, 4 is gasified to generate raw synthetic gas 12. The raw synthetic gas 12 is substantially composed of carbon monoxide (CO) and hydrogen (H₂). The raw synthetic gas 12 can further comprise impurities, such as carbon dioxide (CO₂), methane (CH₄), water (H₂O), nitrogen (N₂), hydrogen sulphide (H₂S), ammonia (NH₃), hydrogen chloride (HCl), tar and particulate impurities. The particulate impurities are composed, for example, of ash and soot particles. In gasification, the biomass 2, 4 is at least partially combusted in the gasifier 34 to generate raw synthetic gas 12. The gasifier 34 can be a fluidized bed gasifier, such as a circulating fluidized bed gasifier or a bubbling fluidized bed gasifier. In one embodiment, gasification of the biomass 2, 4 is performed using oxygen gasification by feeding into the gasifier 34 at least oxygen and steam 8 at a temperature of approximately 200° C. In connection with gasification, the compounds of the biomass 2, 4 react endothermically with steam forming carbon monoxide and hydrogen as well as exothermically with oxygen creating carbon monoxide, carbon dioxide and more steam. As the result of the above reactions, raw synthetic gas 12 is created. The gasifier 34 can be adapted to function, for example, at a pressure of 10 bar and a temperature of 850° C.

In one embodiment, the raw synthetic gas 12 created in the gasifier 34 is led out from the upper part of the gasifier 34. Correspondingly, the base ash 10 created in gasification is led out the lower part of the gasifier 34, as is shown in FIG. 1. The raw synthetic gas 12 is led from the gasifier into raw synthetic gas purification, which can be performed in one or more stages. In one embodiment, purification of the raw synthetic gas 12 comprises at least pre-purification of the raw synthetic gas 12, in which from the raw synthetic gas 12 are separated the largest particulate impurities, and purification of the raw synthetic gas 12, in which from the raw synthetic gas are removed particulate impurities of smaller particle size. Purification of the raw synthetic gas 12 can also comprise other purification operations in addition to the removal of particulate impurities.

FIG. 1 shows one embodiment of gasification of a biomass 2, 4, in which the raw synthetic gas 12 is initially led from the gasifier 34 into pre-purification, which is performed by two pre-purifiers installed in series, a first 36 and a second pre-purifier 38. In one embodiment, the pre-purifiers comprise a first cyclone 36 and a second cyclone 38. In the embodiment according to FIG. 1, the raw synthetic gas 12 is led from the gasifier 34 into the first cyclone 36, in which from the raw synthetic gas 12 are removed the very largest particulate impurities, which comprise, for the most part, bed material 16 of the fluidized bed, which has left the gasifier 34 along with the raw synthetic gas 12. The bed material 16 is substantially composed of sand. The bed material 16 separated from the raw synthetic gas 12 in the first pre-purifier 36 is preferably led back to the gasifier 34, as is shown in FIG. 1.

From the first pre-purifier 36, the raw synthetic gas 12 is led into the second pre-purifier 38, which preferably comprises a second cyclone. In the second cyclone 38 from the raw synthetic gas 12 are separated particulate impurities, which can comprise, for the most part, ash as well as soot and possible charring remnants. In this description and in the claims, for the particulate impurities separated from the raw synthetic gas in the second cyclone 38 is used the common name cyclone ash 20. The particle size of the cyclone ash 20 separated by the second cyclone 38 can be, for example, at least 50 μm, preferably at least 40 μm and especially preferably at least 30 μm. The particle size of the cyclone ash 20 separated in the second cyclone 38 depends on the properties of the second cyclone 38 as well as on the speed of flow of the raw synthetic gas 12. In other words, the average particle size of the cyclone ash 20 can be, for example, smaller or as large as 30-50 μm.

In another embodiment, pre-purification of the raw synthetic gas 12 can also comprise three or more raw synthetic gas 12 pre-purification stages. In addition to the cyclones 36, 38 or instead of them, pre-purification can be further performed also by some other alternative pre-purification apparatus, which is capable of separating particulate impurities from hot raw synthetic gas 12.

The raw synthetic gas 18 pre-purified in pre-purification is led into the synthetic gas purification arrangement 40, in which purified synthetic gas 28 is provided from the pre-purified raw synthetic gas 18. The purification arrangement 40 preferably comprises at least one gas purification device suitable for the purification of hot gases, most suitably a particulate purifier 41, in which from pre-purified raw synthetic gas 18 are removed particles of small particle size, which could not be removed in the pre-purifiers 36, 38. Preferably, the particulate purifier 41 is a particulate filter, such as a hot gas filter, for example, a ceramic filter. Other kinds of particulate purifiers 41 suitable for purification of gases, which are capable of removing from pre-purified raw synthetic gas 18 particulate impurities of smaller particle size than those the pre-purifiers 36, 38 could remove, can also be used. In addition to the particulate purifier 41, the purification arrangement 40 can comprise also one or more other devices for the purification of pre-purified raw synthetic gas 18.

The particles separated by the particulate purifier 41 used in the purification arrangement 40 are substantially composed of ash particles, soot and possible other small particulate impurities. In this connection, for the particles separated in the purification arrangement 40 is used the common name filter ash 24. The particulate filter used in the purification arrangement is preferably adapted to separate from the pre-purified raw synthetic gas particles, whose average particle size is greater than 30 μm, preferably particles, whose average particle size is greater than 15 μm, or more preferably particles, whose average particle size is greater than 5 μm. In one embodiment, the average particle size of the filter ash 24 separated in the hot gas filter from pre-purified raw synthetic gas is approximately 6-10 μm. Cyclone ash 20 and filter ash 24 can be mixed together into mixed ash 26.

According to the present invention, the cyclone ash 20 separated in the purification of the raw synthetic gas 12 generated in the gasification of a biomass 2, 4 and the filter ash 24 separated in purification from the pre-purified raw synthetic gas 18 are utilized in the production of the raw material used in producing black dye pigment. The carbon content of cyclone ash 20 and filter ash 24 can be 20-95%, for example, approximately 50-70 percent by weight. Both cyclone ash 20 and filter ash 24 can be further purified and treated in an ash treatment arrangement such that the carbon black content of the ash is at least 50 percent by weight and the average particle size is at the most 1500 nm. By carbon black is herein meant the dye pigment provided by combusting or gasifying a biomass 2, 4 and which is substantially just elemental carbon.

According to the present invention, the raw material used in producing black dye pigment can be produced either from ash separated from raw synthetic gas 12 in pursuance of pre-purifiers 36, 38, for example, from cyclone ash 20, from ash separated from pre-purified raw synthetic gas 18, for example, from filter ash 24 or from mixed ash 26. Thus, the filter ash 24 separated from the pre-purified raw synthetic gas 18 in the purification arrangement 40 can be used for the production of the raw material 46 used in producing black dye pigment. Further, also the cyclone ash 20 separated from raw synthetic gas 12 in the cyclone 38 can be used for the production of the raw material 46 used in producing black dye pigment.

In the alternative embodiment, said raw material can be produced from both cyclone ash 20, filter ash 24 and mixed ash 26 by purifying and treating ash 20, 24, 26 in an ash treatment arrangement 53, in which ash 20, 24, 26 is further purified and treated. Cyclone ash 20 and filter ash 24 can be mixed together into mixed ash 26 before they are led into the ash treatment arrangement 53 or, alternatively, they can be purified and treated separately, after which they can be mixed together into mixed ash 26 or from these can be separately prepared said raw material 46. In other words, in the present invention is provided a raw material 46, which is substantially composed of ash 20, 24, 26 to be created from the purification of raw synthetic gas 12 created in connection with the gasification of a biomass 2, 4.

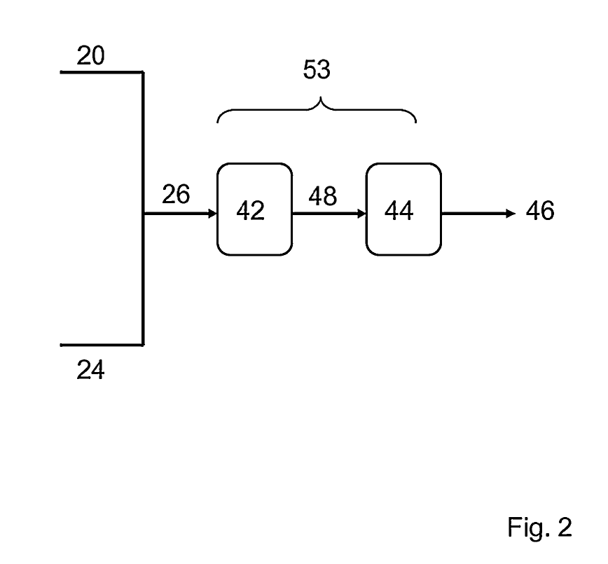

FIG. 2 shows one embodiment of the present invention, in which cyclone ash 20 and filter ash 24 are mixed together into mixed ash 26. The mixed ash 26 is guided into the ash treatment arrangement 53, which comprises grinding 42 and purification 44. As the result of the ash treatment arrangement 53, the raw material 46 used in producing dye pigment is obtained. In grinding 42, the average particle size of the mixed ash 26 is reduced. Grinding 42 can be performed in one or more consecutive grinding stages, in which the particle size of the mixed ash 26 is reduced in stages to a desired value. The ash 20, 24, 26 can also be thermally treated before grinding, wherein the goal is to get the coal into a preferred form in regard to grinding and/or utilization.

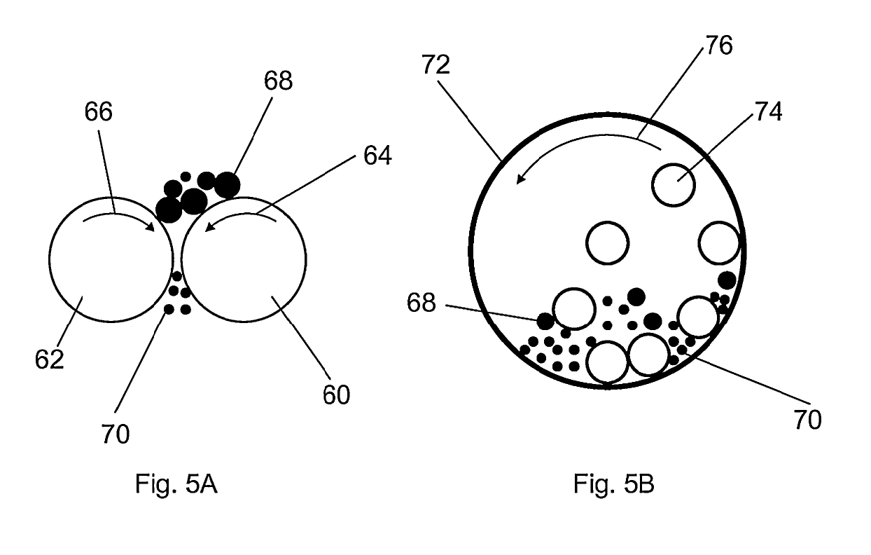

Grinding or reduction of particle size 42 can be performed, for example, using dry grinding, which comprises grinding the mixed ash 26 by one or more grinding mills, preferably a bead mill, jet mill or pin mill. In dry grinding, a dry raw material 46 is obtained, which can, as needed, be further pelletized into grains of the desired size. Dry grinding can be performed, for example, in three stages using bead mills. One example of a bead mill is shown in FIG. 5B. A bead mill generally comprises a cylindrical hollow frame 72, which is adapted to be rotatable around its longitudinal axis, as is shown by the arrow 76 in FIG. 5B. Inside the cylinder 72 are placed beads, balls or similar 74, which, as the cylinder 72 rotates, crush the large particles 68 of the ash 20, 24, 26 into smaller particles 70. When grinding 42 is performed in stages, the ash 20, 24 26 can be moved from one bead mill to the other. The consecutive bead mills always have smaller beads 74, which enables reduction of the particle size of the ash 20, 24, 26 in stages.

In the alternative embodiment, grinding is performed is by wet grinding, which comprises grinding the ash using water or varnish and grinding bodies and possibly a grinding aid, such as CMC or sodium hexaphosphate. By means of wet grinding, a raw material paste can be provided, from which can further be produced black dye pigment. Wet grinding can also be a combination of dry and wet grinding. Wet grinding can comprise grinding of the ash 20, 24, 26 using water or varnish and grinding bodies as well as a bead mill as well as a roller mill. In one embodiment, the ash 20, 24, 26 is initially ground by a bead mill and thereafter by a roller mill. FIG. 5A shows one example of a roller mill, which comprises a first roller, which is adapted to be rotatable around its longitudinal axis by means of a power source according to the arrow 64, as well as a second roller 62, which preferably rotates freely in the direction of the arrow 66. The rotation of the first and second roller 60, 62 feeds the ash 20, 24, 26 between the rollers, where the large particles 68 of the ash disintegrate into smaller particles 70 under the influence of the crushing force of the rollers 60, 62. It must be noted that the roller mill can also be used in dry grinding, and that wet grinding can also be performed using only roller mills.

According to the present invention, the particle size of cyclone ash 20, filter ash 24 or mixed ash 26 is reduced in one or more grinding devices such that the average particle size of the raw material 46 to be obtained is smaller than 1500 nm, preferably smaller than 500 nm, and especially preferably smaller than approximately 300 nm.

According to FIG. 2, the ash 48 ground in the mill 42 is further led into purification of the ash, which is performed in one or several ash purification devices 44. Purification of the ash can comprise purifying the ground ash 48 to at least partially remove from the ground ash metals, non-metals or other possible impurities. Removing metals, non-metals or other possible impurities from the ground ash 48 can be performed using a purification method, which is selected from the following purification methods: acid wash, water wash, wash with an organic solvent or flotation, or a combination of these. Purification performed with an acid wash device, water wash device, solvent wash device or a flotation device is preferably performed such that a raw material 46 is provided, whose carbon black content is at least 50 percent by weight. Carbon black content can be preferably greater than approximately 80 percent by weight or even greater than 96 percent by weight. According to the above, the ash purification device is adapted to increase the carbon black content of the ash to a desired value.

The treatment of mixed ash according to FIG. 2 can further comprise removing large particles from the ash or sorting the ash into fractions of different particle sizes. In one embodiment, this removal of large particles can be performed by at least one separation device, which can be a screen, sieve, hydrocyclone, centrifuge or an air separator. Separating large particles from the ash or dividing the ash into different fractions can be performed before grinding 42, after grinding 42 or after purification 44 of the ash. Separating large particles from the ash or dividing the ash into different fractions can also be performed between consecutive grinding stages, wherein the large particles can be returned to the previous grinding. stage.

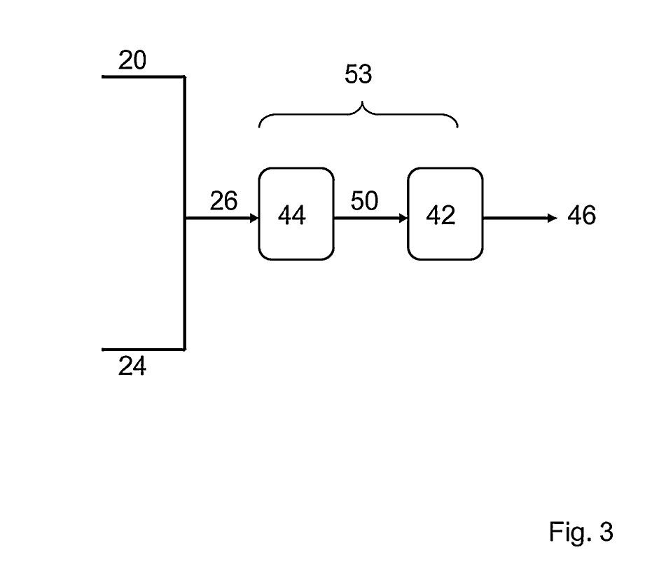

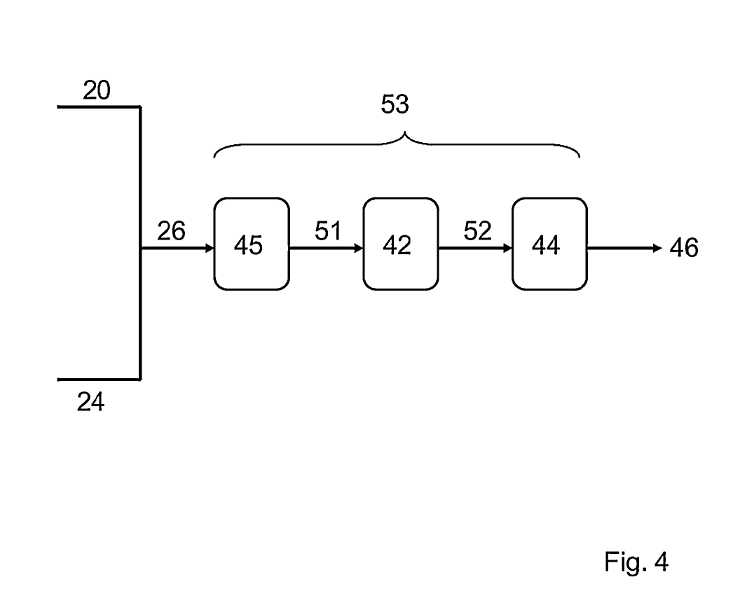

FIG. 3 shows one alternative embodiment of the present invention, in which mixed ash 26 is initially led into purification 44 and the purified ash 50 is further led into grinding 42, from which is obtained the raw material 46. FIG. 4 shows yet another alternative embodiment of the present invention, in which mixed ash 26 is initially led into the first pre-purification 45. Pre-purified ash 51 is led into grinding 42, from which the pre-purified and ground ash 52 is further led into purification 44, from which is obtained the raw material 46. Pre-purification 45 can comprise the same purification methods and devices as actual purification 44.

The ash purification and treatment devices and methods presented above can also be applied separately to cyclone ash 20 and to filter ash 24.

The present invention provides the raw material 46 for producing black dye pigment. According to that presented above, the raw material 46 is substantially composed of cyclone ash 20 and/or filter ash 24 separated from the raw synthetic gas 12 created in connection with the gasification of a biomass 2, 4. The raw material can also be composed exclusively of cyclone ash 20 separated in purification of the raw synthetic gas created in connection with the gasification of a biomass and/or filter ash 24 separated from the purification of pre-purified raw synthetic gas 18. The carbon black content of the provided raw material 46 is at least 50 percent by weight and the average particle size is smaller than 1500 nm, preferably smaller than 500 nm, and especially preferably smaller than approximately 300 nm. The ash can be cyclone ash 20, filter ash 24 or mixed ash 26 formed when mixing cyclone ash 20 and filter ash 24. In other words, the present invention enables the use of ash 20, 24, 26 separated from raw synthetic gas 12, 18 in the purification of raw synthetic gas 12, 18 generated in the gasification of a biomass 2, 4 for producing black dye pigment.

It is obvious to the person skilled in the art that, as technology develops, the fundamental idea of the present invention can be implemented in many different manners. Thus, the present invention and its embodiments are not limited to only the examples above, rather they may vary within the scope of the claims.

1. A method for the production of the raw material used in producing black dye pigment, characterized in that in the method:
biomass is gasified in a gasifier to generate raw synthetic gas;
raw synthetic gas is purified in one or more gas purification devices to provide purified raw synthetic gas and to separate ash from the synthetic gas; and
from the ash separated from the raw synthetic gas obtained in the purification of the raw synthetic gas is produced the raw material used in producing black dye pigment.

2. A method according to claim 1, characterized in that raw synthetic gas is pre-purified to form pre-purified raw synthetic gas.

3. A method according to claim 2, characterized in that the raw synthetic gas is purified in one or more gas purification devices to form pre-purified raw synthetic gas and to separate cyclone ash from the raw synthetic gas.

4. A method according to claim 2, characterized in that the pre-purified raw synthetic gas is purified in one or more gas purification devices to form purified synthetic gas and to separate filter ash from the pre-purified raw synthetic gas.

5. A method according to claim 1, characterized in that as the raw material in the production of black dye pigment is used one of the following: cyclone ash, filter ash or mixed ash obtained when mixing cyclone ash and filter ash.

6. A method according to claim 1, characterized in that production of the raw material comprises purifying the ash to at least partially remove metals, non-metals or other possible impurities from the ash.

7. A method according to claim 6, characterized in that removal of metals, non-metals or other possible impurities from the ash is performed by one or more of the following purification methods: acid wash, water wash, wash with an organic solvent and flotation.

8. A method according to claim 6, characterized in that the ash is purified such that the carbon black content of the ash is at least 50 percent by weight.

9. A method according to claim 1, characterized in that producing the raw material comprises reducing the average particle size of the ash.

10. A method according to claim 9, characterized in that reducing the average particle size of the ash is performed by dry grinding, which comprises grinding the ash in a grinding mill.

11. A method according to claim 9, characterized in that grinding the ash is performed by wet grinding, which comprises grinding the ash in a grinding mill using water or varnish and grinding bodies and a grinding aid.

12. A method according claim 9, characterized in that the average particle size of the ash is reduced such that the average particle size of the raw material is smaller than 1500 nm, preferably smaller than 500 nm, and especially preferably smaller than approximately 300 nm.

13. A method according to claim 1, characterized in that producing the raw material comprises sorting the ash into fractions of different particle sizes.

14. A method according to claim 1, characterized in that producing the raw material comprises thermal treatment of the ash.

15. A raw material for producing black dye pigment, characterized in that the raw material is substantially composed of ash to be created in the purification of the raw synthetic gas created in connection with the gasification of a biomass.

16. A raw material according to claim 15, characterized in that the carbon black content of the raw material is at least 50 percent by weight, preferably at least 80 percent by weight, and especially preferably more than 96 percent by weight.

17. A raw material according to claim 15, characterized in that the average particle size of the raw material is less than 1500 nm, preferably less than 500 nm, and especially preferably less than approximately 300 nm.

18. A raw material according to claim 15, characterized in that the ash to be created in the purification of the raw synthetic gas is one of the following: cyclone ash separated from raw synthetic gas, filter ash separated from pre-purified raw synthetic gas or mixed ash obtained when mixing cyclone ash and filter ash.

19. An apparatus for producing the raw material used in producing black dye pigment, which apparatus comprises:
a gasifier for generating raw synthetic gas; and
at least one gas purification device for separating the ash in raw synthetic gas from the raw synthetic gas,
characterized in that the apparatus further comprises an ash treatment arrangement in at least one gas purification device for refining the separated ash into the raw material used in producing black dye pigment.

20. An apparatus according to claim 19, characterized in that the ash treatment arrangement comprises at least one grinding device for reducing the particle size of the ash, which grinding device comprises at least one bead mill, jet mill, pin mill or roller mill.

21. An apparatus according to claim 19, characterized in that the grinding device is adapted to reduce the average particle size of the ash to be smaller than 1500 nm, preferably smaller than 500 nm, and especially preferably smaller than approximately 300 nm.

22. An apparatus according to claim 19, characterized in that the ash treatment arrangement comprises at least one separation device for removing large particles from the ash or for sorting the ash into fractions of different particle sizes, which separation device comprises one of the following: a screen, sieve, hydrocyclone, centrifuge or an air separator.

23. An apparatus according to claim 19, characterized in that the ash treatment arrangement comprises at least one ash purification device for removing the metals, non-metals and possible other impurities contained in the ash, which ash purification device comprises one or more of the following purification devices: an acid wash device, water wash device, solvent wash device and a flotation device.

24. An apparatus according to claim 23, characterized in that the ash purification device is adapted to increase the carbon black content of the ash to at least 50 percent by weight, preferably more than 80 percent by weight, and especially preferably more than 96 percent by weight.

25. An apparatus according to claim 1, characterized in that the gas purification device comprises a cyclone for forming the pre-purified raw synthetic gas and separating the cyclone ash from the raw synthetic gas and that at least a portion of the cyclone ash is adapted to be led into the ash treatment arrangement.

26. An apparatus according to claim 19, characterized in that one or more gas purification devices comprise a particulate filter for forming the purified synthetic gas and separating the filter ash from the pre-purified raw synthetic gas, and that a least a portion from the filter ash is adapted to be led into the ash treatment arrangement.

27. The use of ash created in the purification of raw synthetic gas generated in the gasification of a biomass for producing black dye pigment.
